(19) United States
(12) Patent Application Publication
(10) Pub. No.: US 2004/0240137 A1
(43) Pub. Date: Dec. 2, 2004

(54) Microarray device

(76) Inventors: Stefan Fisher-Fruhholz, Gottingen (DE); Eric Jallerat, Ville D'Array (FR)

Correspondence Address: Dennis E Stenzel, Chernoff Vilhauer McClung & Stenzel, 601 S W 2nd Avenue, Suite 1600, Portland, OR, 97204-3157, US

(21) Appl. No.: 10/493,333

(22) PCT Filed: Nov. 22, 2002
(86) PCT No.: PCT/EP02/13109

(30) Foreign Application Priority Data
Dec. 10, 2001 (DE) 101 60 605.2
Feb. 14, 2002 (DE) 102 06 152.1
Jun. 3, 2002 (DE) 102 34 568.1

(51) Int. Cl. H01H 73/00

(52) U.S. Cl. 361/115

(57) ABSTRACT

Microporous membranes useful as a microarray for testing, e.g., biomolecules are created by exposure to a laser beam by means of which a grid having a predetermined pattern of reduced porosity is established.

This is a §371 of PCT/EP02/13109, and claims priority of DE 101 60 605.2 filed Dec. 10, 2001, DE 102 06 152.1 filed Feb. 14, 2002 and DE 102 34 568.1 filed Jun. 3, 2002.

### BACKGROUND OF THE INVENTION

Microarrays are an excellent tool for testing a large number of known different molecules against an unknown substance. A microarray generally consists of a small surface which is subdivided or subdividable into a plurality of smaller zones to make a density of 1000 to 100,000 of these smaller zones per cm². These smaller zones can be made to be singly responsive, individually and independently from one another. In a typical application this means a small quantity of liquid containing one or more reagents may be added to or removed from each of these smaller zones. Under normal circumstances, it is best that each zone is isolated from its neighboring zones, so that no material or data is exchanged between the zones. In this manner, each zone can have specific reagents bound to the zone's surface. A reaction can then be carried out over the entire surface of the microarray. This reaction, because of the different reagents on the surfaces of each zone, can lead to varying results at each individual zone. The results or signals so produced can then be made available from each zone, independently of any other.

Commercially available microarrays are typically supported on glass or silicon substrates. As an example, nucleic acid arrays, such as DNA-arrays (or Biochips) are made so that nucleic acid oligomers, such as DNA- and RNA-oligomers are affixed to a solid matrix by mechanical or photochemical means, e.g., by contact printers such as a type printer, a needle printer, or an ink jet printer.

Typical substances analyzed with the use of microarrays include all types of biological molecules and cells such as oligonucleotides, expressed sequence tags (ESTs) or EST reads from mRNA (cDNAs), proteins, peptides, cells, cell fragments, and tissues. Other chemical moieties can also be deposited upon the microarray to accommodate tests, e.g., for environmental protection.

Analyses with the aid of mircoarrays are described in Ross et al., 24 Nature Genet. 227 (2000) and in Weinstein et al. 275 Science 343 (1997). Both articles studied the application of ESTs to the surfaces of microarrays for the identification of cDNA libraries, that is to say, to provide genomic survey sequences (GSS) for the characterization of complex genes or gene homologs of other species. The next step in the analyses deposited mRNA samples from a cell line or from a cancer cell sample, permitting a large number of samples to be investigated simultaneously. Separation of the target molecules on the microarray is achieved by the creation of an appropriate separating distance between the separate zones on the surface of the microarray.

In determining the size of the zones on the microarray surface, the surface tension of and the nature of the separating agent are of essential importance. If the surface tension of the separating agent is low, and the microarray substrate is hydrophilic, then a very small quantity of the separating agent may spread out from 1 nl to more than 200 μm in diameter for a given zone. On this account, in order to repress the tendency of the zones to spread out and still maintain a high density of zones, the microarray surface may be rendered hydrophobic by, for example, silanization. This is particularly effective in the analysis of oligonucleotides by glass substrate microarrays. In FIG. 1, for example, there is depicted a liquid reagent-containing droplet placed on a hydrophobic surface, which, after drying, can produce a reagent zone having a diameter less than 100 μm. In FIG. 2, there is depicted a liquid reagent-containing droplet which has been placed on a hydrophilic surface, which, after drying, can produce a reagent zone having a diameter much greater than 200 μm.

In the course of drying, the reagent-containing sample tends to concentrate in the periphery of the zone. If additional reagents are added to the same zone, a sensitivity problem arises, since the added reagent finds the initial reagent-containing sample only at the periphery, as opposed to the middle, of the zone. Because of this density and concentration problem, it is best to use silanized glass as a substrate for nucleic acid microarrays.

With conventional, state-of-the-art microarrays, it is difficult if not impossible to deposit a droplet of a solution containing a higher reagent concentration on a given zone of a microarray and obtain a uniform distribution of the reagent over the entire zone. Instead, at least some material transfer takes place between neighboring zones, i.e., droplets in adjacent zones at least partially run together. To help avoid this leaching problem porous membranes may be employed as the microarray surface. However, even using porous membranes as a microarray surface, it has not been possible to create microarrays having a droplet spread of less than 200 μm, preventing the formation of narrowly circumscribed zones on the surface of the microarray.

As a consequence of the foregoing, it has not been possible to create a microarray having a porous membrane surface that is cross-hatched and profiled such as one can easily do with glass as a substrate, for depositing a reagent-containing droplet onto a very small zone on the microarray's surface. In addition, only limited quantities of the deposited reagent can be deposited on the surface of a porous membrane-type microarray.

Thus, it is an object of the present invention to provide a microarray having a plurality of zones arrangeable into a predetermined pattern, wherein the zones can receive a desired reagent in high concentration, and whereby either no exchange or limited exchange of material or data takes place between neighboring zones.

### BRIEF SUMMARY OF THE INVENTION

The invention comprises a microarray device utilizing a microporous polymeric membrane which has a multiplicity of porous or microporous zones, all densely arranged in a predetermined pattern. Each of the zones can be individually manipulated so as to permit or not permit an exchange of material between the zones.

The invention is based on the recognition that a microarray device having a microporous membrane for the reagent-receiving substrate can be treated so as to alter its pore structure in a predetermined pattern so as to create a grid consisting of lines having either no pores at all or pores of diminished porosity that demarcate microporous zones that are separated from adjacent microporous zones by an optimal distance.

The porous material can be self-supporting, or it can be applied onto a support. The porous material can even be formed on the support, for example, a polymeric membrane may be cast from a polymer solution onto a glass or ceramic plate in conventional fashion. An exemplary self-supporting material is an asymmetric polymeric membrane, which exhibits a pore structure wherein larger pores from a first surface extend through the membrane to the second surface, where the diameter of the larger pores of the first surface approximately conically taper to the second surface, so as to form pores with a much smaller diameter on the second surface; in many cases no pores at all are present on the second surface, forming a “skin,” known in the membrane arts as an asymmetric skinned membrane. In the case of an asymmetric skinned membrane, the microarray device of the present invention can be created wherein the pore structure, which exists only to a predetermined depth in the membrane, is so altered at predetermined locations so that no passageways exist between the non-treated areas, or at least the porosity is sufficiently restricted to prevent or alter the exchange of material between adjacent non-treated zones. In this way, that portion of the membrane which exhibits no porosity effectively functions as a support for the segregated porous zones. In the case of a membrane having smaller pores on the second surface, such pores can be closed up to a predetermined depth.

### BRIEF DESCRIPTION OF THE SEVERAL VIEWS OF THE DRAWINGS

FIG. 1 is a schematic drawing of a single droplet of a reagent-containing solution deposited on a hydrophobic substrate.

FIG. 2 is a schematic drawing of a single droplet of a reagent-containing solution deposited on a hydrophilic substrate.

FIG. 3 is a plan view of a schematic drawing of an exemplary surface of the microarray device of the invention depicting a patterned grid burned into the surface.

FIG. 4 is a cross-sectional view of the device shown in FIG. 3.

FIG. 5 is a schematic, three-dimensional view of discrete zones burned into the surface of the microarray device of the invention.

FIG. 6 is a schematic presentation of the control of discrete zones on the surface of the microarray device of the invention, depicting two zones containing absorbed reagent, six zones containing no reagent, and a single droplet containing a reagent about to be absorbed by a third zone.

FIG. 7 is an exemplary depiction of the dimensions of the zones on the surface of the microarray device of the invention.

FIG. 8 is an exemplary depiction of the shape and placement of zones on the surface of the microarray device of the invention.

FIG. 9 is an exemplary depiction of the application of a test sample onto a zone of the microarray device of the invention.

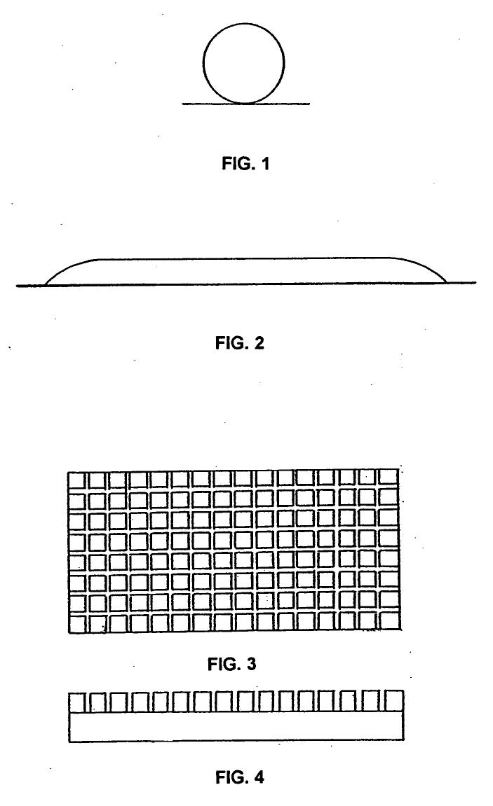

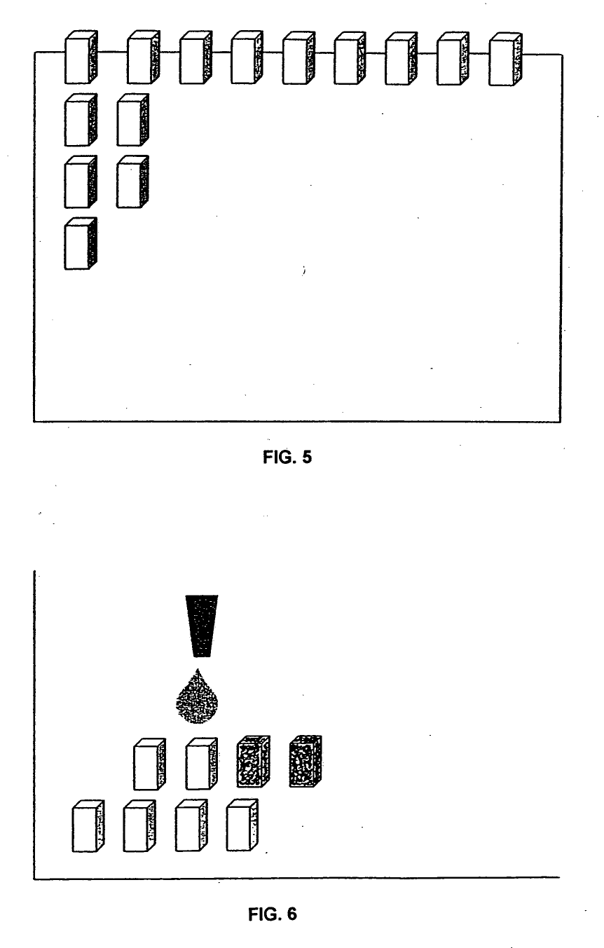

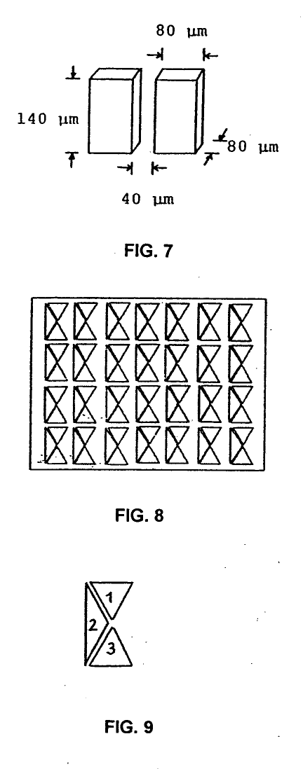

### DETAILED DESCRIPTION OF PREFERRED EMBODIMENTS

The treatment of the porous material for the alteration of the pore structure in a predetermined pattern can be carried out in various ways. One way this can be done is by first inscribing the porous material with fine, cross-hatched lines to create a grid by, for example, milling, engraving or stamping; the inscribing of grid lines is then followed by the destruction of pore structure along the grid lines preferably by, for example, exposure to a laser beam. The use of a laser to effect pore destruction offers particular advantages for the development of very fine microarrays and, by adjustment of the intensity and duration of the laser beam, permits the formation of totally non-porous or partially porous lines. With the aid of a laser beam, the finest, non-porous lines can be produced by melting, particularly in the case of thermoplastic microporous material. In the case of non-thermoplastic materials which do not melt upon irradiation by a laser beam, the porous material may simply be burned away by the laser beam. Thus, a predetermined non-porous pattern can be formed in the porous material, leaving discrete porous zones suitable for absorption of test reagents or bio-molecules. In the case of a porous material applied onto a support, the porous material may be completely ablated down to the support in a predetermined pattern, again leaving behind discrete porous test zones.

In the context of the present invention, the term “microarray device” refers to a device having a surface containing up to 1,000,000 discrete porous zones per square centimeter of surface area, preferably from about 20 to about 100,000, each of which are separated from one another by non-porous areas or areas having reduced porosity relative to the porosity of the porous zones.

In the present invention the term “microporous material” means a membrane having pores with an average pore diameter of from about 0.001 to about 100 μm, more preferably pores with an average pore diameter of from about 0.01 to about 30 μm. In a particularly preferred embodiment of the inventive microarray device the microporous material is a microporous asymmetric polymeric membrane having pores of that size in their greatest dimension.

The separation of the microporous zones offers the possibility of selective activation of porosity/microporosity regions. Further, the inventive microarray devices, owing to their large surface area, may also be used as inventory repositories for sample libraries. In addition, the porous structures can serve as matrices for micro devices on unstructured membranes.

As previously noted, the porous microarray device of the present invention has a multiplicity of porous zones preferably separated by laser-produced non-porous or partially porous lines in a desired pattern. The zones can be of any desired geometric shape, including rectangular, round, oval, triangular or any combination of these shapes. For instance, in FIGS. 8-9, the depicted arrangement of triangular zones 1, 2 and 3 in close proximity to one another allows a test sample to migrate into the neighborhood of the proximal apexes of the triangles. Zones 1-3 are sufficiently separated that no material or data exchange (“cross-talk”) can take place from one zone to another. However, by appropriate reduction in the intensity and/or duration of the laser beam, zones may also be formed that are not completely separated from each other, allowing a limited exchange of material via pores that are not destroyed.

Modification of the porosity of the non-porous zones or zones with diminished porosity which separate the porous zones can be accomplished in virtually any manner. This modification is first dependent upon the desired type and dimensions of the non-porous areas, and secondly upon the type of porous material used.

The inventive microarray devices have a porous or a microporous surface, which, by appropriate treatment, preferably laser radiation, has been subdivided into small, three-dimensional, porous or microporous zones. A preferred substrate material is an asymmetric microporous membrane that has pores that vary greatly in size from the inner to the outer surface, with the pores on the outer surface having an average diameter of from about 0.01 to about 30 μm. For example, a typical asymmetric microfiltration membrane has an inner surface wall area per pore of some 100 to 400 cm², relative to 1 m² of outer surface of the membrane. This means that such a membrane, in comparison to a smooth surface such as glass, plastic, or silicon dioxide, can bind a large number of specific reagents to its surface, thereby permitting substantially higher concentrations of reagents such as peptides, proteins, or DNA per unit surface area of the microarray. This in turn permits reagents to be distributed uniformly over the entire microporous structure and thus be available at any position within each zone, including in the middle of the zone, for a reaction.

The invention permits the preparation of a microarray which may have a series of chemically different surfaces. These surfaces could be, for example, surfaces with ion exchange groups or with functional groups such as basic or acidic groups, which allow a specific adsorption or covalent binding of various bio-molecules. Because of the advantageous microporous structure of the zones of the inventive microarray devices, these readily absorb a deposited substance, without the necessity of introducing hydrophilic groups into the target zone. Furthermore, no “cross-talk” or leaching between the zones occurs, even when there is a high density of the zones on the microarray.

Since greater quantities of substances may be deposited on the inventive microarray devices their capture on the substrate may be facilitated with, for example, the use of charge coupled camera systems. With such a system, because of the increased concentration of a target substance, which arises from the greater quantity of available substance deposited, one obtains a better signal-to-noise ratio between the signal and the background.

By using precise control of the laser beam or by using a photographic mask, it is possible to impart any desired pattern into the membrane. For instance, as shown in FIG. 3, a regular pattern of squares or rectangles can be made. In this fashion even more complex structures and patterns can be imparted to the surface of the microarray in a single step.

Typically the predetermined pattern is first burned into the microporous membrane by the laser, followed by deposition of the desired substance(s) onto individual zones. However, the burning-in of the pattern and the deposition of the substance(s) can also be conducted simultaneously.

According to the invention microporous zones may be created that vary in volume from nanoliter to microliter, whereby microporous zones can be generated with a basic area in the micrometer range, for instance, an 80×80 μm square. The distance separating the zones can be still less, namely, 40 μm, thereby permitting an extremely high density of test zones in the microarray. In the case of the use of, for example, microporous membranes with a thickness in the range of 10 to 500 μm, it is possible to achieve corresponding thicknesses of the zones, wherein the surface area of the zones is in an advantageous relationship to the thickness of the zone, meaning a ratio of from about 1:2 to about 1:3 of a least dimension of the zone to the membrane thickness. In the case of an 80×80 μm square zone, the zone could have a depth or thickness of 140 μm, as shown in FIG. 6. When the microarray is mounted on a support, the thickness of the complete assembly preferably lies in the range of 100 μm to 4 mm, more preferably 200 μm to 3 mm, and even more preferably 300 μm to 2 mm.

Exemplary porous or microporous membranes suitable for use in the present invention include, without limitation, polyamides (such as nylon 66), polyvinylidene fluoride, polyethersulfone, polysulfonates, polycarbonates, polypropylene, cellulose acetate, cellulose nitrate, regenerated cellulose with a chemically modified surface and mixtures thereof. Membranes of cellulose acetate, cellulose nitrate, and regenerated cellulose with chemically modified surfaces are preferred.

Regenerated cellulose membrane surfaces may be chemically modified by the inclusion of such functional groups as aldehydes, epoxides, sulfonic acids, carboxylic acids, quaternary ammonium groups and diethyl ammonium groups. Because of the presence of such functional groups, peptides, proteins and nucleic acids such as DNA may be reversibly or covalently bound to the microarray. The inclusion of such functional groups also permits the formation of selective and partial reactive groups. For example, an epoxide-modified regenerated cellulose membrane can be oxidized to the corresponding aldehyde after its fabrication into a microarray by an oxidizing agent such as iodine.

The microarray device of the present invention may be made with a microporous membrane alone or laminated to an inorganic or organic support. Exemplary organic supports include virtually any polymeric film. Advantageously, the support is in the form of a sheet, especially one made of polyvinyl chloride (PVC). A predetermined pattern of lines is then burned into the surface of the microporous membrane. The intensity and duration of the laser beam may be adjusted so that the laser beam totally destroys or distorts the microporous structure of the membrane at the locations subjected to the laser beam. When this occurs, only hydrophobic, blackened tracks remain as far as deep under the molecular plane. These tracks prevent or suppress liquid transport between the zones which have been created, depending upon their depth. The intensity of the laser beam and/or the duration of the radiation can also be adjusted so that the microporous structure of the membrane is destroyed only to a certain depth, so that there remains a limited connection of the so-formed zones to each other so as to permit limited material exchange.

The invention is further described in the following Example, which is merely exemplary of the fabrication of a microarray device of the present invention, and is not to be construed as limiting the invention in any way.

### EXAMPLE

A 10 cm×10 cm microporous nitrocellulose membrane with pores having an average pore diameter of 0.2 μm and a thickness of approximately 140 μm was laminated onto a PVC sheet as a support. A grid of 40 μm-wide lines was burned into the nitrocellulose membrane by a laser (Nd YAG), creating a pattern of 80×80 μm square microporous zones on the PVC support, with each square separated from adjacent squares by 40 μm. The so-fabricated microarray device had about 6900 discrete microporous zones fully separated from each other by an intervening non-porous area 40 μm wide, with each zone having a surface area of about 6400 μm² and a thickness of about 140 μm.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. A microarray device comprising a microporous membrane having multiple porous zones arranged in a predetermined pattern, said multiple porous zones being separated from each other by gaps selected from non-porous areas and areas with diminished porosity relative to the porosity of said porous zones, wherein said gaps have been created by exposure to a laser beam.

2. The device of claim 1 wherein said membrane is selected from the group consisting of polyamides, polyvinylidene fluoride, polyethersulfones, polysulfonates, polycarbonates, polypropylene, cellulose acetate, cellulose nitrate, regenerated cellulose with a chemically modified surface, and mixtures thereof.

3. The device of claim 2 wherein said chemically modified surface comprises a functionalized surface wherein the functional group introduced to the surface is selected from the group consisting of aldehydes, epoxides, sulfonic acids, carboxylic acids, quaternary ammonium groups and diethyl ammonium groups.

4. The device of claim 1 including a support for said membrane.

5. The device of claim 4 wherein said support is selected from the group consisting of a plastic film, a plastic sheet and a plastic plate.

6. The device of claim 5 wherein said support is polyvinyl chloride.

7. The device of any of claims 1-6 wherein said porous zones measure from about 40 to about 100 μm on a side.

8. The device of claim 7 wherein said porous zones are separated from each other by from about 20 to about 60 μm.

9. The device of claim 8 having a thickness of from about 10 to about 500 μm.

10. A process for the manufacture of a microarray device, comprising the steps:
(a) providing a microporous membrane; and
(b) inscribing thereon in a predetermined pattern regions selected from the group consisting of non-porous areas and areas with diminished porosity by exposure of said membrane to a laser beam.

11. The process of claim 10 wherein said microporous membrane is selected from the group consisting of polyamides, polyvinylidene fluoride, polyethersulfones, polysulfonates, polycarbonates, polypropylene, cellulose acetate, cellulose nitrate, regenerated cellulose with a chemically modified surface, and mixtures thereof.

12. The process of claim 11 wherein said chemically modified surface comprises a functionalized surface selected from the group consisting of aldehydes, epoxides, sulfonic acids, carboxylic acids, quaternary ammonium groups and diethyl ammonium groups.
